(19) United States
(12) Patent Application Publication
(10) Pub. No.: US 2004/0092421 A1
(43) Pub. Date: May 13, 2004

(54) Microbicidal fluid systems using antimicrobial polymers

(76) Inventors: Peter Ottersbach, Windeck (DE); Beate Kossmann, Hagen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/471,017

(22) PCT Filed: Jan. 22, 2002
(86) PCT No.: PCT/EP02/00584

(30) Foreign Application Priority Data
Mar. 8, 2001 (DE) 10111144.4

(51) Int. Cl. C11D 17/00

(52) U.S. Cl. 510/417; 510/475

(57) ABSTRACT

The invention relates to microbicidal fluid systems using antimicrobal polymers, to a method for the production of fluid systems by means of emulsion polymerization and to the use of microbicidal emulsions. The invention also relates to a method for producing microbicidal emulsions, wherein microcrobicidal polymers are produced by emulsion polymerization of corresponding monomers. Generally, emulsion polymers have higher molecular weights than polymers which are produced, for example by solution or substance polymerization. Consequently, it is also possible to produce extremely high-molecular antimicrobial polymers. The microbial polymers can contain nitrogen and/or phosphorous groups. Emulsion polymerization to form microbicidal polymers is carried out in a way known per se i.e. water, an emulsifier, at least one monomer and one thermal or photochemical radical starter are made to react in such a way as to obtain an emulsion. It is possible to add more monomer or optionally another monomer or one of the comonomers mentioned hereafter. Ionic or non-ionic emulsifiers such as polyethylene glycol derivatives, polyethylene glycol ether, especially 4-octylphenol polyethoxylate (also known under the brand name Triton) alkylbenzol sulfonates, alkylsulfates, alkyl sulfonates i.e. ethoxylated fatty alcohols, alkyl phenols or fatty acids can be used as emulsifiers.

The invention relates to microbicidal fluid systems using antimicrobial polymers.

It is highly undesirable for bacteria to become established or to spread on the surfaces of pipelines, containers or packaging. Slime layers frequently form, and permit sharp rises in microbial populations, which can lead to persistent impairment of the quality of water or of beverages or foods and even to spoilage of the product and to harm to the health of consumers.

Bacteria must be kept away from all areas of life where hygiene is important. This affects textiles for direct body contact, especially in the genital area, and those used for the care of the elderly or sick. Bacteria must also be kept away from the surfaces of the furniture and instruments used in patient care areas, particularly in areas for intensive care or neonatal care, and in hospitals, especially in areas where medical intervention takes place, and also in isolation wards for critical cases of infection, and in toilets.

A current method of treating equipment, or the surfaces of furniture and textiles, to counter bacteria, either when this becomes necessary or else as a precautionary measure, is to use chemicals or solutions of them, or else mixtures, which, as disinfectants, have a fairly broad, general antimicrobial effect. Chemical agents of this kind act non specifically and are themselves frequently toxic or irritant, or form degradation products which are hazardous to health. In addition, people frequently exhibit intolerance to these chemicals once they have become sensitized.

Another approach to counteracting surface spread of bacteria is the incorporation of antimicrobial substances into a matrix.

Another challenge, of constantly increasing significance, is the prevention of algal growth on surfaces, since there are now many external surfaces on buildings with plastic cladding, which is particularly susceptible to colonization by algae. As well as giving an undesirable appearance, this can in some circumstances also impair the function of the components concerned. One relevant example is the colonization by algae of surfaces which have a photovoltaic function.

Another form of microbial contamination for which, again, no technically satisfactory solution has yet been found is the fungal infestation of surfaces. For example, Aspergillus niger infestation of joints or walls in damp areas not only impairs appearance but also has serious health implications, since many people are allergic to the substances given off by the fungi, and the results can even be serious, chronic respiratory diseases.

In the marine sector, the fouling of boats' hulls is a cost factor, since it is attended by an increase in the boat's flow resistance and hence by a marked increase in fuel consumption. Problems of this kind have to date generally been countered by incorporating toxic heavy metals or other, low molecular biocides into antifouling coatings with the aim of mitigating the problems described. For this purpose, the damaging side effects of such coatings are accepted, but, as society's environmental awareness rises this state of affairs is proving increasingly problematic.

Thus, for example, U.S. Pat. No. 4,532,269 discloses a terpolymer of butyl methacrylate, tributyltin methacrylate and tert-butylaminoethyl methacrylate. This copolymer is used as an antimicrobial marine coating, in which the hydrophilic tert-butylaminoethyl methacrylate promotes the slow erosion of the polymer and thus releases the highly toxic tributyltin methacrylate as the active antimicrobial substance.

In these applications the copolymer prepared with aminomethacrylates is only a matrix or carrier substance for added active microbicidal substances which are able to diffuse or migrate from the carrier. Polymers of this kind lose their effect fairly rapidly, when the necessary minimum inhibitory concentration (MIC) is no longer attained at their surface.

From European patent applications 0 331 518 and 0 862 858, moreover, it is known that copolymers of dialkylaminoalkylacrylamide and ethylene and, respectively, copolymers of tert-butylaminoethyl methacrylate, an ester of methacrylic acid with a secondary amino function, inherently possess microbicidal properties. In order effectively to counter unwanted adaptations of the microbial life forms, particularly in view of the development by microbes of resistance, as is known from antibiotics research, it will be necessary in the future too to develop systems based on innovative compositions and possessing enhanced efficacy.

Further antimicrobial, amine-functionalized copolymers are known from WO 01/85813, WO 00/69936, WO 01/87998, DE 199 40 697, and WO 01/18077.

The antimicrobial systems described are solid materials which are used in powder form or as a coating. On economic grounds and from an occupational hygiene standpoint, however, it is often desirable to avoid the roundabout route involving the preparation of a solid when producing coating systems, and instead to obtain a fluid product directly. Fluid products possess the great advantage that operations of precipitation, drying, and grinding can be dispensed with entirely, avoiding not least the problematic handling of inhalable dusts. Moreover, fluid products are easy to convey and store by means of pump and tank systems, and are also efficiently metered. In addition, on ecotoxicological grounds, there is an increasing desire for a solvent-free formulation, so that fluid products based on water possess a great competitive advantage. Where necessary, such products can also be metered directly and precisely into aqueous systems.

Emulsions of chlorinated nitrogen-functionalized polymers are already known from Polymer 40 (1999) 1367-1371. These emulsions are obtained in the presence of ionic emulsifiers and are used as a coating, i.e., in the dried, immobile state, or grafted onto a surface. A disadvantage here is the chlorination of the polymers before they are employed as antimicrobial material.

It is an object of the present invention, therefore, to develop antimicrobial polymers in the form of a fluid system which combines the described advantages of fluid systems with those of inherently antimicrobial polymers.

It has now surprisingly been found that, through the use of emulsifiers in the operation of preparing the antimicrobial polymers, fluid antimicrobial products are obtained which meet in near-ideal fashion the requirements described above.

The present invention accordingly provides microbicidal emulsions comprising microbicidal polymers and nonionic emulsifiers. The emulsions of the invention are miscible with water in any proportion and can therefore be used for disinfecting aqueous systems such as drinking water, cooling water, emulsion paints or other coating materials.

The invention further provides a process for producing microbicidal emulsions which involves preparing microbicidal polymers by emulsion polymerization of corresponding monomers in the presence of nonionic emulsifiers.

The microbicidal polymers may contain nitrogen groups and/or phosphorus groups. Emulsion polymerization to give the microbicidal polymers is conducted in a known way: that is, an emulsion of water, an emulsifier, at least one monomer, and a thermal or photochemical radical initiator is reacted so as to give an emulsion. It is possible to add further monomer, possibly a different monomer, or one of the comonomers specified below, to the reaction.

Preferred monomers for preparing the microbicidal polymers are 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl)acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether and/or 2-aminopropyl vinyl ether.

The microbicidal polymers can be prepared by copolymerization from the stated monomers and at least one further comonomer.

The further comonomers can be acrylates or methacrylates, e.g., acrylic acid, tert-butyl methacrylate or methyl methacrylate, styrene or its derivatives, vinyl chloride, vinyl ethers, acrylamides, acrylonitriles, olefins (ethylene, propylene, butylene, isobutylene), allyl compounds, vinyl ketones, vinylacetic acid, vinyl acetate or vinyl esters, especially for example methyl methacrylate, ethyl methacrylate, butyl methacrylate, tert-butyl acrylate, methyl acrylate, ethyl acrylate, butyl acrylate, tert-butyl methacrylate, tert-butylaminoethyl esters.

As the emulsifier it is possible to use nonionic emulsifiers such as polyethylene glycol derivatives, polyethylene glycol ethers, especially 4-octylphenol polyethoxylate (also known under the brand name Triton), ethoxylated fatty alcohols or alkylphenols.

Such antimicrobial coatings can be obtained, for example, directly by spreading or coating the antimicrobially active emulsion onto surfaces or else metering it beforehand into further coating formulations. Since emulsion polymers generally possess higher molecular weights than polymers prepared, for example, by solution polymerization or bulk polymerization it is also possible in this way to prepare antimicrobial polymers of very high molecular mass. Furthermore, such emulsions are useful for the antimicrobial treatment or preservation of other industrially employed emulsions, since in the case of such combination the resultant products are generally very homogeneous. Another ready possibility is the direct addition of antimicrobial emulsions to aqueous systems, for the purpose for example of disinfecting cooling water circuits.

### Use of the Modified Polymer Substrates

The present invention further provides for the use of the antimicrobial emulsions prepared in accordance with the invention for preparing antimicrobial products, and provides the products thus produced per se. Such products are based preferably on polyamides, polyurethanes, polyether-block-amides, polyesteramides or polyesterimides, PVC, polyolefins, silicones, polysiloxanes, polymethacrylate, polyacrylates or polyterephthalates, metals, wood, stone, concrete, glass, and ceramics, which have surfaces coated with emulsions of the invention or else are obtained in the form of a paint or another coating material.

Antimicrobial products of this kind, by way of example and in particular, are machinery parts for food processing, components of air conditioning systems, coated pipes, semifinished products, roofing, items for bathroom and toilet use, kitchen wear, components of sanitary installations, components of cages and stalls for animals, recreational products for children, components of water systems, food packaging, touch panels of instruments, and contact lenses, building materials, construction timber and wooden garden products.

The emulsions of the invention can be used wherever there is a need for surfaces which as far as possible are free from bacteria, free from algae and free from fungus, i.e., microbicidal surfaces or surfaces having anti-adhesion properties. Examples of uses for the emulsions of the invention are found in the following sectors:

Marine: boat hulls, docks, buoys, drilling platforms, ballast water tanks

Home: roofing, basements, walls, facades, glasshouses, sun protection, garden fencing, wood preservation

Sanitary: public conveniences, bathrooms, shower curtains, toilet items, swimming pools, saunas, jointing, sealing compounds

Every-day requisites: machinery, kitchens, kitchen wear, sponges, recreational products for children, food packaging, milk processing, drinking water systems, cosmetics

Machinery parts: air conditioning systems, ion exchangers, process water, solar units, heat exchangers, bioreactors, membranes

Medical engineering: contact lenses, diapers, membranes, implants

Consumer articles: automobile seats, clothing (socks, sports wear), hospital equipment, door handles, telephone handsets, public transport, cages for animals, cash registers, carpeting, wallpapers

The present invention further provides for the use of the emulsions of the invention or process-produced hygiene products or medical engineering articles. The above listings of preferred materials apply correspondingly. Examples of such hygiene products include toothbrushes, toilet seats, combs, and packaging materials. The designation “hygiene articles” also includes other objects which can come into contact with a large number of people, such as telephone handsets, handrails on stairways, door handles, window catches, and also grab straps and grab handles on public transport. Examples of medical engineering articles include catheters, tubes, backing films or else surgical instruments.

The microbicidal emulsions are preferably used as an emulsifier or as an addition to other emulsions such as lattices, emulsion paints, cooling lubricants, water-based coating materials or cosmetic formulations and for the purpose of disinfecting cooling water circuits.

The present invention further provides microbicidal dispersions prepared from the microbicidal emulsions of the invention by drying and subsequent redispersing.

The microbicidal emulsions of the invention can also be used for producing microbicidal coatings or as an adhesive or adhesive additive. The microbicidal dispersions of the invention produced from the emulsions in accordance with the invention can likewise be used for producing microbicidal coatings and also as or in adhesives.

The emulsions are freed from the water by a known method, preference being given to vacuum evaporators. The solid obtained in that way can then simply be packed and transported. Redispersing in water produces a dispersion which has virtually the same microbicidal properties as the original emulsion and which possesses a sufficient stability.

The present invention is further described by the examples below, which are intended to illustrate the invention but not to restrict its scope as set out in the claims.

### EXAMPLE 1

3 mL of dimethylaminopropylmethacrylamide (from Aldrich), 4.4 g of Triton X 405 (from Aldrich), 25 mL of DI [deionized] water and 0.1 g of potassium peroxodisulfate (from Aldrich) are introduced into a three-necked flask and heated to 60° C. under a stream of argon. Thereafter a further 23 mL of dimethylaminopropylmethacrylamide are added dropwise over a period of 4 hours. The mixture is subsequently stirred at 60° C. for 2 hours more, after which the resultant emulsion is cooled to room temperature.

### EXAMPLE 1a

0.02 mL of the emulsion from example 1 is admixed with 20 mL of a test microbicidal suspension of Pseudomonas aeruginosa which has a microbe count of 10⁷ per mL, and the mixture is shaken. After a contact time of 24 hours 1 mL of the test microbicidal suspension is withdrawn and the microbe count in the experimental mixture is measured. After this time it is no longer possible to detect Pseudomonas aeruginosa microbes.

### EXAMPLE 1b

0.02 mL of the emulsion from example 1 is admixed with 20 mL of a test microbicidal suspension of Staphylococcus aureus which has a microbe count of 10⁷ per mL, and the mixture is shaken. After a contact time of 2 hours 1 mL of the test microbicidal suspension is withdrawn and the microbe count in the experimental mixture is measured. After this time it is no longer possible to detect Staphylococcus aureus microbes.

### EXAMPLE 2

2 mL of tert-butylaminoethyl methacrylate (from Aldrich), 5.7 g of Triton X 405 (from Aldrich), 25 mL of DI water and 0.08 g of potassium peroxodisulfate (from Aldrich) are introduced into a three-necked flask and heated to 60° C. under a stream of argon. Thereafter a further 23 mL of tert-butylaminoethyl methacrylate are added dropwise over a period of 4 hours. The mixture is subsequently stirred at 60° C. for 2 hours more, after which the resultant emulsion is cooled to room temperature.

### EXAMPLE 2a

0.02 mL of the emulsion from example 2 is admixed with 20 mL of a test microbicidal suspension of Pseudomonas aeruginosa which has a microbe count of 10⁷ per mL, and the mixture is shaken. After a contact time of 24 hours 1 mL of the test microbicidal suspension is withdrawn and the microbe count in the experimental mixture is measured. After this time it is no longer possible to detect Pseudomonas aeruginosa microbes.

### EXAMPLE 2b

0.02 mL of the emulsion from example 2 is admixed with 20 mL of a test microbicidal suspension of Staphylococcus aureus which has a microbe count of 10⁷ per mL, and the mixture is shaken. After a contact time of 2 hours 1 mL of the test microbicidal suspension is withdrawn and the microbe count in the experimental mixture is measured. After this time it is no longer possible to detect Staphylococcus aureus microbes.

### EXAMPLE 2c

5 mL of the emulsion from example 2 are placed in a petri dish and then the water is withdrawn from the product by drying it at 70° C. for a period of 24 hours. 0.1 g of the dried product is then admixed with 20 mL of a test microbicidal suspension of Pseudomonas aeruginosa which has a microbe count of 10⁷ per mL, and the mixture is shaken. After a contact time of 24 hours 1 mL of the test microbicidal suspension is withdrawn and the microbe count in the experimental mixture is measured. After this time it is no longer possible to detect Pseudomonas aeruginosa microbes.

### EXAMPLE 2d

An aluminum plate measuring 2×2 cm is immersed for 5 seconds in 5 mL of the emulsion from example 2. The water is then removed from the coating by drying at 70° C. for a period of 24 hours. The dried plate is placed on the bottom of a glass beaker, admixed with 20 mL of a test microbicidal suspension of Pseudomonas aeruginosa which has a microbe count of 10⁷ per mL, and shaken. After a contact time of 24 hours 1 mL of the test microbicidal suspension is withdrawn, and the microbe count of the experimental mixture is measured. After this time it is no longer possible to detect Pseudomonas aeruginosa microbes.

### EXAMPLE 3

2 mL of tert-butylaminoethyl methacrylate (from Aldrich), 5.5 g of Triton X 405 (from Aldrich), 25 mL of DI water and 0.08 g of potassium peroxodisulfate (from Aldrich) are introduced into a three-necked flask and heated to 60° C. under a stream of argon. Thereafter a mixture of 13 mL of tert-butylaminoethyl methacrylate and 10 mL of methyl methacrylate are added dropwise over a period of 4 hours. The mixture is subsequently stirred at 60° C. for 2 hours more, after which the resultant emulsion is cooled to room temperature.

### EXAMPLE 3a

0.02 mL of the emulsion from example 3 is admixed with 20 mL of a test microbicidal suspension of Pseudomonas aeruginosa which has a microbe count of 10⁷ per mL, and the mixture is shaken. After a contact time of 24 hours 1 mL of the test microbicidal suspension is withdrawn and the microbe count in the experimental mixture is measured. After this time the microbe count has dropped.

### EXAMPLE 3b

0.02 mL of the emulsion from example 3 is admixed with 20 mL of a test microbicidal suspension of Staphylococcus aureus which has a microbe count of 10⁷ per mL, and the mixture is shaken. After a contact time of 2 hours 1 mL of the test microbicidal suspension is withdrawn and the microbe count in the experimental mixture is measured. After this time it is no longer possible to detect Staphylococcus aureus microbes.

1. Microbicidal emulsions comprising microbicidal polymers and nonionic emulsifiers.

2. A microbicidal emulsion as claimed in claim 1, characterized in that the microbicidally active polymers contain nitrogen groups.

3. A microbicidal emulsion as claimed in claim 1, characterized in that the microbicidally active polymers contain phosphorus groups.

4. A microbicidal emulsion as claimed in claim 1, characterized in that the nonionic emulsifiers are polyethylene glycol derivatives.

5. A microbicidal emulsion as claimed in claim 4, characterized in that the nonionic emulsifier is 4-octylphenol polyethoxylate.

6. A microbicidal emulsion as claimed in any of claims 1 to 5, characterized in that the microbicidally active polymers have been prepared from at least one of the following polymers: 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl)-acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether, 3-aminopropyl vinyl ether.

7. A microbicidal emulsion as claimed in any of claims 1 to 6, characterized in that microbicidal polymers contain further comonomers.

8. A microbicidal emulsion as claimed in claim 7, characterized in that the further comonomers are compounds from the group consisting of acrylates, methacrylates, styrene, styrene derivatives, vinyl chloride, vinyl ethers, acrylamides, acrylonitriles, olefins, allyl compounds, vinyl ketones, vinylacetic acid, vinyl acetate or vinyl esters.

9. A microbicidal emulsion as claimed in claim 7 or 8, characterized in that the further comonomers are acrylic acid, tert-butyl methacrylate, methyl methacrylate, ethyl methacrylate, butyl methacrylate, tert-butyl methacrylate, methyl acrylate, ethyl acrylate, butyl acrylate, tert-butyl acrylate or tert-butylaminoethyl esters.

10. A process for producing microbicidal emulsions, characterized in that microbicidal polymers are prepared by emulsion polymerization in the presence of nonionic emulsifiers.

11. The process for producing microbicidal emulsions as claimed in claim 10, wherein the microbicidally active polymers contain nitrogen groups.

12. The process for producing microbicidal emulsions as claimed in claim 10, wherein the microbicidally active polymers contain phosphorus groups.

13. The process for producing microbicidal emulsions as claimed in claim 10, wherein the nonionic emulsifiers are polyethylene glycol derivatives.

14. The process for producing microbicidal emulsions as claimed in claim 13, wherein the nonionic emulsifier is 4-octylphenol polyethoxylate.

15. A process for producing microbicidal emulsions as claimed in any of claims 10 to 14, wherein the microbicidally active polymers have been prepared from at least one of the following polymers: 2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, N-(3-dimethylaminopropyl) acrylamide, 2-methacryloyloxyethyltrimethylammonium methosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether, 3-aminopropyl vinyl ether.

16. The process for producing microbicidal emulsions as claimed in any of claims 10 to 15, wherein microbicidal polymers contain further comonomers.

17. The process for producing microbicidal emulsions as claimed in claim 16, wherein the further comonomers are compounds from the group consisting of acrylates, methacrylates, styrene, styrene derivatives, vinyl chloride, vinyl ethers, acrylamides, acrylonitriles, olefins, allyl compounds, vinyl ketones, vinylacetic acid, vinyl acetate or vinyl esters.

18. The process for producing microbicidal emulsions as claimed in claim 16 or 17, wherein the further comonomers are acrylic acid, tert-butyl methacrylate, methyl methacrylate, ethyl methacrylate, butyl methacrylate, tert-butyl methacrylate, methyl acrylate, ethyl acrylate, butyl acrylate, tert-butyl acrylate or tert-butylaminoethyl esters.

19. A microbicidal dispersion produced by drying a microbicidal emulsion as claimed in any of claims 1 to 9 and subsequently redispersing it in water.

20. The use of the microbicidal emulsions as claimed in any of claims 1 to 9 as an addition to other emulsions.

21. The use as claimed in claim 20, characterized in that the other emulsions are latices, emulsion paints, water-based coating materials, cooling lubricants or cosmetic formulations.

22. The use of the microbicidal emulsions as claimed in any of claims 1 to 9 for disinfecting cooling water circuits.

23. The use of the microbicidal dispersion as claimed in claim 19 as an addition to other emulsions, to latices, emulsion paints, water-based coating materials or for disinfecting cooling water circuits.

24. The use of the microbicidal emulsions as claimed in any of claims 1 to 9 as an emulsifier.

25. The use of the microbicidal emulsions as claimed in any of claims 1 to 9 for producing microbicidal coatings or as an adhesive.

26. The use of the microbicidal dispersions as claimed in claim 19 for producing microbicidal coatings or as an adhesive.
